(19) United States
(12) Patent Application Publication
(10) Pub. No.: US 2010/0037655 A1
(43) Pub. Date: Feb. 18, 2010

(54) Hydrogen Recovery From A Mixture Of Hydrogen and Hydrocarbons At Low Pressure And Of Low Hydrogen Content

(75) Inventor: Bhadra S. Grover, Sugar Land, TX (US)

Correspondence Address: AIR LIQUIDE;Intellectual Property, 2700 POST OAK BOULEVARD, SUITE 1800, HOUSTON, TX, 77056, US

(73) Assignee: Air Liquide Process and Construction Inc., Houston, TX (US)

(21) Appl. No.: 12/330,544

(22) Filed: Dec. 9, 2008

Related U.S. Application Data
(60) Provisional application No. 61/088,546, filed on Aug. 13, 2008.

(51) Int. Cl. C01B 3/50; C01B 3/52; F25J 3/00

(52) U.S. Cl. 62/623; 423/248

(57) ABSTRACT

A method for recovering hydrogen from a gas stream is presented. This method includes introducing a feed gas stream comprising hydrogen and methane to a first cold box, thereby producing a first hydrogen-enriched stream, and a first methane-enriched stream; then introducing the first hydrogen-enriched stream to a first feed compressor, thereby producing a compressed first hydrogen-enriched stream. The method includes introducing the compressed first hydrogen-enriched stream to a second cold box, thereby producing a second hydrogen-enriched stream, and a second methane-enriched stream; then introducing the second hydrogen-enriched stream to a second feed compressor, thereby producing a compressed second hydrogen-enriched stream. The method includes introducing the compressed second hydrogen-enriched stream to a third cold box, thereby producing a third hydrogen-enriched stream, and a third methane-enriched stream. This method includes introducing the third hydrogen-enriched stream to a third feed compressor, thereby producing a compressed third hydrogen-enriched stream; then introducing the compressed third hydrogen-enriched stream to a PSA, thereby producing a high pressure, high purity hydrogen stream, and a tail gas stream. This method includes introducing a first part of the tail gas stream to a tail gas compressor, and recycling the compressed tail gas back to the feed gas stream; then combining the first methane-enriched stream, the second methane-enriched stream, the third methane-enriched stream, and a second part of the tail gas stream into a fuel stream. And this method includes introducing the fuel stream to a methane compressor.

### CROSS-REFERENCE TO RELATED APPLICATIONS

This application claims the benefit of U.S. Provisional Application No. 61/088,546, filed Aug. 13, 2008, the entire contents of which are incorporated herein by reference.

### FIELD OF THE INVENTION

This invention relates to method for recovering hydrogen from a mixture of hydrogen and hydrocarbons at low pressure and low hydrogen content.

### BACKGROUND

Hydrogen is used in a variety of industrial processes. Because of the demand for hydrogen, particularly for hydrogen that is essentially free of impurities, an equally wide variety of techniques have been developed for separating impurities from hydrogen.

One method for purifying hydrogen, as described in U.S. Pat. No. 5,492,682, involves a two-step process. The first step of the two part process involves the removal of carbon monoxide by contacting the stream containing carbon monoxide with a nickel catalyst to form nickel-carbonyl. This carbon monoxide-free stream is then passed through a second reaction zone wherein it is contacted with a titanium nickel catalyst in order to further purify the stream by removing methane and carbon dioxide.

Another purification method, as described in U.S. Pat. No. 4,056,373, involves the use of a selectively permeable noble-metal membrane. In this method, a membrane is selected such that only hydrogen will pass through. An example is the use of a palladium-alloy filter coil. There, the purification filter separates hydrogen from the impurities present in the hydrogen stream by limiting the passage to hydrogen.

Another purification method, as described in U.S. Pat. No. 4,654,047, uses a two-step membrane/cryogenic process. The process involves a first step of separating a stream of gases into a hydrogen-rich component and a hydrogen-lean component by selective permeation through a cellulose acetate, polysulfone, or polyimide type membrane or hollow filter. The hydrogen-lean stream is subsequently treated by a cryogenic process to remove some of the remaining impurities to produce a more enriched hydrogen stream.

Still another technique for the purification of hydrogen, as described in U.S. Pat. No. 3,251,652, begins with a stream comprised of hydrogen and hydrocarbons. This stream is contacted with steam and air to convert the hydrocarbons to carbon monoxide. That stream is then treated with a gaseous diffusion process (utilizing a palladium-silver alloy membrane) to separate the hydrogen from the carbon monoxide. The stream from that process containing mostly carbon monoxide (and some hydrogen) is then contacted with steam to produce carbon dioxide and hydrogen through a shift reaction. This mixture is then passed through a second palladium-silver alloy membrane to separate the hydrogen and carbon dioxide.

Notwithstanding these various processes, there still remains a need for an improved method for economically producing pure hydrogen from a gas mixture that is lean in hydrogen and is at a relatively low pressure.

### SUMMARY

The present invention is a method for recovering hydrogen from a gas stream. This method includes introducing a feed gas stream comprising hydrogen and methane into a first cold box, thereby producing a first hydrogen enriched stream and a first methane enriched stream. The first hydrogen enriched stream is introduced into a first feed compressor, thereby producing a compressed first hydrogen enriched stream. The compressed first hydrogen enriched stream is introduced to a second cold box, thereby producing a second hydrogen enriched stream, and a second methane enriched stream. The second hydrogen enriched stream is introduced into a second feed compressor, thereby producing a compressed second hydrogen enriched stream. The compressed second hydrogen enriched stream is introduced into a third cold box, thereby producing a third hydrogen enriched stream, and a third methane enriched stream. The third hydrogen enriched stream is introduced into a third feed compressor, thereby producing a compressed third hydrogen enriched stream. The compressed third hydrogen enriched stream is introduced into a PSA, thereby producing a high pressure, high purity hydrogen stream, and a tail gas stream. A first part of said tail gas stream is introduced into a tail gas compressor, and said compressed tail gas is recycled back to said feed gas stream. Said first methane enriched stream, said second methane enriched stream, said third methane enriched stream, and a second part of said tail gas stream is combined into a fuel stream. The fuel stream is introduced into a methane compressor. The method of the present invention may include a feed gas stream comprising hydrogen. The feed gas stream may comprise 50% hydrogen or less. In another embodiment, the feed gas stream may comprise between about 40% and about 50% hydrogen. In another embodiment the feed gas stream comprises about 40% hydrogen. The method may include the compressed third hydrogen enriched stream having a pressure between about 200 psig and about 500 psig. In another embodiment, the compressed third hydrogen enriched stream may have a pressure of between about 250 psig and about 350 psig. In another embodiment, the compressed third hydrogen enriched stream may have a pressure greater than about 300 psig, alternatively the compressed third hydrogen enriched stream has a pressure of about 310 psig. This method may include the pressure of about 300 psig being achieved in less than three compressor stages, and wherein said feed gas is enriched in less than three cold boxes.

The method of the present invention may include the feed gas pressure being between about 50 psig and about 80 psig. The method may include the feed stream being compressed before going to said first cold box. This method may also include the third hydrogen enriched stream comprising between about 80% and about 95% hydrogen. This method may include at least one of said first cold box, second cold box and said third cold box being auto-refrigeration type. This method may include the auto-refrigeration type cold box utilizing the expansion of at least one of said first methane enriched stream, said second methane enriched stream, and said third methane enriched stream. This method may include at least one of said first cold box, second cold box and said third cold box using an external refrigeration loop. This method may include the external refrigeration loop being of the type selected from the group consisting of methane loop, nitrogen loop, and mixed refrigerant loop.

This method may include the first feed compressor, said second feed compressor, and said third feed compressor being discrete machines. This method may include at least two of said first feed compressor, said second feed compressor, and said third feed compressor being combined into a single machine. This method may include the methane rich streams being expanded to different pressure levels. This method may include the expanded methane rich streams being recompressed to fuel system pressure. This method may include the feed gas containing impurities such as carbon monoxide, and/or ethylene.

This method may include the feed gas containing 0.1-2% ethylene. This method may include the methane rich streams containing ethylene. This method may include the ethylene containing methane rich streams being processed for separation of ethylene from methane. This method may include the ethylene separation being done by fractionation in a staged column. The staged column is reboiled by any one of the compressed hydrogen streams or the feed gas stream. This method may include the staged column being refluxed by condensed overhead stream of the staged column.

### BRIEF DESCRIPTION OF DRAWINGS

The present invention may be understood by reference to the following description taken in conjunction with the accompanying drawings, and in which:

FIG. 1 is a schematic representation of one embodiment of the present invention.

### DETAILED DESCRIPTION OF PREFERRED EMBODIMENTS

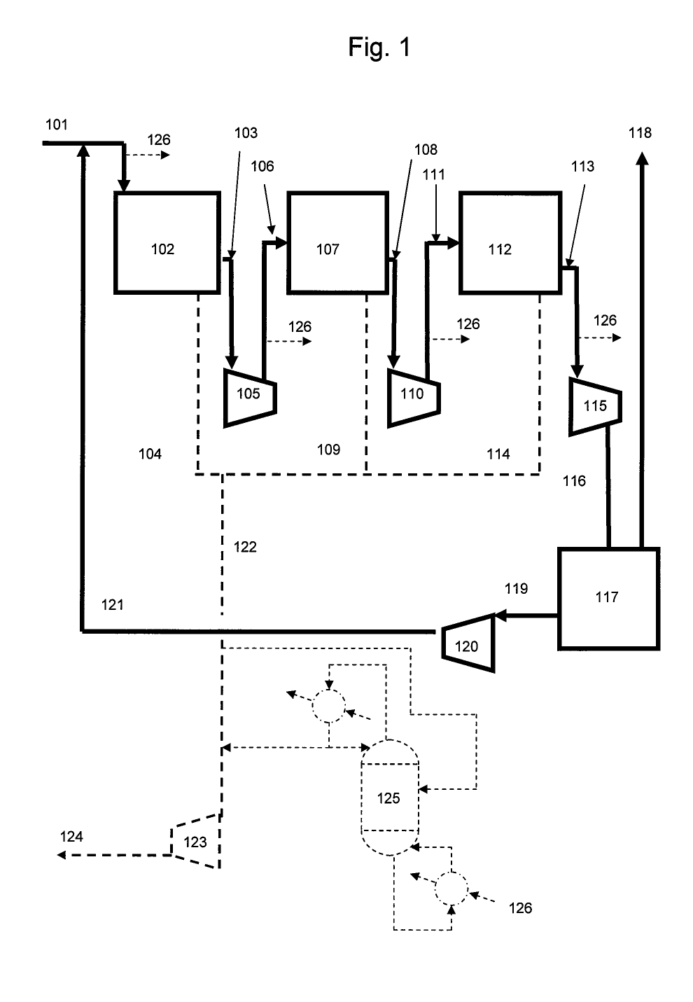

Referring to FIG. 1, a feed gas stream 101 is provided. Feed gas stream 101 contains hydrogen and at least one other gas. The other gas may be a hydrocarbon, in one embodiment this hydrocarbon is methane. In one embodiment, feed gas stream 101 may contain hydrogen and methane. With regard to feed gas stream 101, the proportion of hydrogen to the at least one other gas will be such that the feed gas stream 101 contains less than about 50% hydrogen. In an alternative embodiment, feed gas stream 101 will contain about 40% hydrogen.

In the method of the present invention, feed gas stream 101 is introduced into a first cold box 102, where it is cryogenically separated into a first hydrogen enriched stream 103 and a first methane enriched stream 104. The feed gas stream 101 utilized may contain impurities such as carbon monoxide and/or ethylene. Feed gas stream 101 may contain between about 0.3% and about 2% ethylene. The first hydrogen enriched stream 103 is introduced into a first feed compressor 105, thus producing a compressed first hydrogen enriched stream 106.

The compressed first hydrogen enriched stream 106 is then introduced into a second cold box 107, wherein it is separated into a second hydrogen enriched stream 108 and a second methane enriched stream 109. The second hydrogen enriched stream 108 is introduced into a second feed compressor 110, thus producing a compressed second hydrogen enriched stream 111.

The compressed second hydrogen enriched stream 111 is introduced into a third cold box 112, where it is separated into a third hydrogen enriched stream 113 and a third methane enriched stream 114. The third hydrogen enriched stream 113 is introduced into a third feed compressor 115, thus producing a compressed third hydrogen enriched stream 116. The third hydrogen enriched stream 116 may have a pressure greater than 300 psig, alternatively the third hydrogen enriched stream 116 may have a pressure of about 310 psig. With regard to the method of the present invention, the hydrogen enriched stream (106, 111), with a pressure of greater than 300 psig, may have had this pressure achieved in less than three compressor stages. In addition, the hydrogen enriched stream (106, 111) may have been enriched in less than three cold boxes.

The third hydrogen enriched stream 116 may comprise between about 80% and about 95% hydrogen. The feed gas stream 101 may have a pressure of between about 50 psig and about 80 psig. The feed gas stream 101 may be compressed before admission into the first cold box 102.

The compressed third hydrogen enriched stream 116 is introduced into a pressure swing adsorption unit (PSA) 117, thereby producing a high pressure, high purity hydrogen stream 118 and a tail gas stream 119. The tail gas stream 119 is split into two parts. One part is introduced into a tail gas compressor 120, and the compressed tail gas 121 is recycled back to feed gas stream 101. The other part of the tail gas is sent to be used as fuel. The first methane enriched stream 104, the second methane enriched stream 109 and the third methane enriched stream 114 from the various stages of the method are combined to form a fuel stream 122. Fuel stream 122 is introduced into a methane compressor 123 and the compressed methane stream 124 may also be used as a fuel.

At least one of the first cold box 102, second cold box 107, and third cold box 112 may be an auto-refrigeration type cold box. The auto-refrigeration type may use the expansion of any of the methane enriched streams 104, 109, 114 as the source of refrigeration. The methane enriched streams 104, 109, 114 may be expanded to different pressure levels. The methane enriched streams 104, 109, 114 may be expanded to pressures between about 5 psig and about 30 psig, alternatively they may be expanded to pressures between about 10 psig and about 20 psig. The expanded methane enriched streams 104, 109, 114 may be recompressed to fuel system pressure. The methane enriched streams 104, 109, 114 may contain ethylene. The methane enriched streams 104, 109, 114 may be processed to separate the ethylene from the methane. Any appropriate separation methods known to one skilled in the art may be used. In one embodiment, the methane enriched streams 104, 109, 114 is processed to separate the ethylene from the methane by fractionation in a staged column 125. The staged column 125 may be reboiled by one or more of the first compressed hydrogen enriched stream, the second compressed hydrogen enriched stream, the third compressed hydrogen enriched stream, or the feed gas stream (shown schematically as stream 126). The staged column 125 may be refluxed by condensed overhead stream of the staged column.

At least one of the first cold box 102, second cold box 107, and third cold box 112 may use an external refrigeration loop. This external refrigeration loop may be a methane loop, a nitrogen loop, or a mixed refrigerant loop.

Any two of the first feed compressor 105, second feed compressor 110, or third feed compressor 115 may be combined into a single compressor. In the alternative, all three of the feed compressors 105, 110, 115 may be combined into a single compressor. All three of the feed compressors 105, 110, 115 may also be discrete machines.

Any two of the first cold box 102, second cold box 107, or third cold box 112 may be combined into a cold box. In the alternative, all three of the cold boxes 102, 107, 112 may be combined into a cold box. All three of the cold boxes 102, 107, 112 may also be discrete cold boxes. Each cold box may have sub-stages where the condensed hydrocarbon is separated at successively lower temperatures. The hydrocarbon stream from each cold box stage 104, 109, 114 and the PSA 119 can be at the same pressure or at different pressures to minimize the recompression power required. The PSA tail gas 121 can be optimized from a low pressure of between about 2 psig to about 5 psig, or to a higher pressure of approximately the fuel header pressure.

It should be noted that one skilled in the art would recognize that alternative embodiments are also possible. Whereas the example above has three cold box/compression stages, in other embodiments a single cold box/compression stage may be appropriate for the given process conditions. In another embodiment, two cold box/compression stages may be necessary for the process conditions present. Likewise, more than three cold box/compression stages may be necessary for certain feed gas compositions.

What is claimed is:

1. A method for recovering hydrogen from a gas stream comprising:
a. introducing a feed gas stream comprising hydrogen and methane to a first cold box, thereby producing a first hydrogen enriched stream, and a first methane enriched stream;
b. introducing said first hydrogen enriched stream to a first feed compressor, thereby producing a compressed first hydrogen enriched stream;
c. introducing a said compressed first hydrogen enriched stream to a second cold box, thereby producing a second hydrogen enriched stream, and a second methane enriched stream;
d. introducing said second hydrogen enriched stream to a second feed compressor, thereby producing a compressed second hydrogen enriched stream;
e. introducing a said compressed second hydrogen enriched stream to a third cold box, thereby producing a third hydrogen enriched stream, and a third methane enriched stream;
f. introducing said third hydrogen enriched stream to a third feed compressor, thereby producing a compressed third hydrogen enriched stream;
g. introducing said compressed third hydrogen enriched stream to a PSA, thereby producing a high pressure, high purity hydrogen stream, and a tail gas stream;
h. introducing a first part of said tail gas stream to a tail gas compressor, and recycling said compressed tail gas back to said feed gas stream;
i. combining said first methane enriched stream, said second methane enriched stream, said third methane enriched stream, and a second part of said tail gas stream into a fuel stream; and
j. introducing said fuel stream to a methane compressor.

2. The method of claim 1, wherein said feed gas stream comprises less than 50% hydrogen.

3. The method of claim 1, wherein said feed gas stream comprises about 40% hydrogen.

4. The method of claim 1, wherein said compressed third hydrogen enriched stream has a pressure greater than 300 psig.

5. The method of claim 1, wherein said compressed third hydrogen enriched stream has a pressure of about 310 psig.

6. The method of claim 1, wherein said pressure of 300 psig is achieved in less than three compressor stages, and wherein said feed gas is enriched in less than three cold boxes.

7. The method of claim 1, wherein the pressure of said feed gas is between about 50 psig and about 80 psig.

8. The method of claim 1, wherein said feed stream is compressed before going to said first cold box.

9. The method of claim 1, wherein said third hydrogen enriched stream comprises between about 80% and about 95% hydrogen.

10. The method of claim 1, wherein at least one of said first cold box, second cold box and said third cold box is an auto-refrigeration type cold box.

11. The method of claim 10, wherein said auto-refrigeration type cold box utilizes expansion of at least one of said first methane enriched stream, said second methane enriched stream, and said third methane enriched stream.

12. The method of claim 1, wherein at least one of said first cold box, second cold box and said third cold box use an external refrigeration loop.

13. The method of claim 12, wherein said external refrigeration loop is of the type selected from the group consisting of methane loop, nitrogen loop, and mixed refrigerant loop.

14. The method of claim 1, wherein said first feed compressor, said second feed compressor, and said third feed compressor are discrete machines.

15. The method of claim 1, wherein at least two of said first feed compressor, said second feed compressor, and said third feed compressor are combined into a single machine.

16. The method of claim 11, wherein said methane rich streams are expanded to different pressure levels.

17. The method of claim 1, wherein said expanded methane rich streams are recompressed to fuel system pressure.

18. The method of claim 1, wherein said feed gas contains impurities such as carbon monoxide and/or ethylene.

19. The method of claim 18, wherein said feed gas contains 0.1-2% ethylene.

20. The method of claim 1, wherein said methane rich streams contain ethylene.

21. The method of claim 20, wherein said ethylene containing methane rich streams are processed for separation of ethylene from methane.

22. The method of claim 21, wherein said ethylene separation is done by fractionation in a staged column.

23. The method of claim 22, wherein the staged column is reboiled by at least one stream selected from the group consisting of the first compressed hydrogen enriched stream, the second compressed hydrogen enriched stream, the third compressed hydrogen enriched stream, and the feed gas stream.

24. The method of claim 21, wherein said staged column is refluxed by condensed overhead stream of the staged column.
